(19) United States
(12) Patent Application Publication
(10) Pub. No.: US 2011/0210567 A1
(43) Pub. Date: Sep. 1, 2011

(54) SECURITY SEAL

(76) Inventor: Ian NAZZARI, Moraga, CA (US)

(21) Appl. No.: 13/043,998

(22) Filed: Mar. 9, 2011

Related U.S. Application Data
(63) Continuation-in-part of application No. 12/817,254, filed on Jun. 17, 2010.
(60) Provisional application No. 61/219,548, filed on Jun. 23, 2009.

(51) Int. Cl. E05C 19/00

(52) U.S. Cl. 292/315; 292/307 R

(57) ABSTRACT

A security seal has an outer body, a locking insert, and a shackle. The locking insert and shackle are received within a cavity of the outer body to be locked therein. Once the locking insert is engaged with the outer body, they cannot be disengaged without showing evidence of the disengagement. The evidence of the disengagement can be in the form of damage to any component of the security seal, in the form of mismatching of marked components of the security seal, or in any other suitable form showing evidence of the disengagement.

This application is a Continuation-In-Part of U.S. patent application Ser. No. 12/817,254 filed Jun. 17, 2010, the entirety of which is incorporated herein by reference, and which claims the benefit of U.S. Provisional Application No. 61/219,548, filed Jun. 23, 2009.

### FIELD OF THE INVENTION

The present invention relates generally to the field of security seals, and more specifically to a security seal that discourages tampering therewith by being configured in a manner such that any tampering therewith will be evident upon visual inspection of the security seal.

### BACKGROUND

Security seals are commonly used to secure closure of utility meters, postal boxes, or other receptacles or devices where it is desired to prevent tampering therewith. Such seals may include a plastic body with a pair of apertures opening at one end of the body and a shackle formed of a piece of U-shaped wire having legs with reversibly bent end portions. When the seal is put into use, the shackle legs are first threaded through a structure to be secured, such as a retaining ring fitted around a cover for an electric meter. The shackle legs are then inserted into the body apertures whereby the reversibly bent end portions engage some form of inner structure of the body for permanent retention. A lateral pulling force on the shackle only forces the reversibly bent end portions into stronger engagement with the body. Thus, the shackle must be severed or otherwise broken, or the seal body must be damaged to open the seal.

In addition to the usual locking mechanisms, security seals typically include some form of tamper-indicating structure. Generally, tamper-indicating structures are designed such that any significant attempts to defeat or tamper with the seal will normally result in altering the seal in such a manner that the attempt will be readily detectable. For example, if any attempt to tamper with the seal is made, portions of the seal may be permanently damaged. Such damage in the seal is typically readily apparent, thereby indicating evidence of tampering.

Although such devices have served the purpose, they have not provided entirely satisfactory results, because some efforts to defeat such structures by picking have proved successful. One such method of picking involves inserting a picking tool into the seal body through openings or spaces where the shackle legs enter the seal body and deforming or cutting the shackle legs to an extent that the legs can be freely withdrawn from the sealed body, reformed, and later replaced in the seal body. Such tools also can be used to deform or cut parts of the seal body securing the shackle Other tampering methods may include dissolving the shackle wire with acid, removing the security seal to tamper with the previously sealed meter, receptacle or device, and replacing the security seal using a replacement shackle.

Embodiments of a security seal according to the present disclosure provide improved security by discouraging tampering therewith by being configured in a manner such that any tampering therewith will be evident upon visual inspection of the security seal.

### SUMMARY

Embodiments of a security seal that provides improved security by discouraging tampering therewith by being configured in a manner such that any tampering therewith will be evident upon visual inspection of the security seal are disclosed herein.

The security seal generally includes a female outer body, a male locking insert configured to be engaged with the female outer body, and a shackle retained between the female outer body and the male locking insert. Once the male locking insert is engaged with the female outer body, they cannot be disengaged without showing evidence of the disengagement. The evidence of the disengagement can be in the form of damage to any component of the security seal, in the form of mismatching of marked components of the security seal, or in any other suitable form showing evidence of the disengagement.

### BRIEF DESCRIPTION OF THE DRAWINGS

These and other features, aspects, and advantages of the present invention will become better understood with regard to the following description, appended claims, and accompanying drawings where:

FIG. 1 is a perspective view of an embodiment of a security seal according to the present disclosure;

FIG. 2 is a front view of the security seal according to FIG. 1;

FIG. 3 is a perspective exploded view of the shackle, locking insert, and outer body of the security seal according to FIG. 1;

FIG. 4 is a perspective exploded view of the shackle assembled with the locking insert, and the outer body of the security seal according to FIG. 1;

FIG. 5 is a side view of the security seal according to FIG. 1;

FIG. 6 is a cross-sectional view of the security seal according to FIG. 1, and taken along lines 6-6 of FIG. 2;

FIG. 7 is a top view of the security seal according to FIG. 1;

FIG. 8 is a cross-sectional view of the security seal according to FIG. 1, and taken along lines 8-8 of FIG. 7;

FIG. 9 is a cross-sectional view of the security seal according to FIG. 1, and taken along the same plane as lines 8-8 of FIG. 7, and showing the security seal in a partially assembled configuration;

FIG. 10 is a perspective view of another embodiment of a security seal according to the present disclosure;

FIG. 11 is a front perspective view of the security seal according to FIG. 10 shown in a partially assembled configuration; and

FIG. 12 is a rear perspective view of the security seal according to FIG. 10 shown in a partially assembled configuration; and

FIGS. 13 and 14 show another embodiment of the security seal according to the present disclosure.

It should be noted that the drawing figures are not necessarily drawn to scale, but instead are drawn to provide a better understanding of the components thereof, and are not intended to be limiting in scope, but rather to provide exemplary illustrations. It should further be noted that the figures illustrate exemplary embodiments of a security seal and the components thereof, and in no way limit the structures or configurations of a security seal and components thereof according to the present disclosure.

### DETAILED DESCRIPTION

### A. Detailed Description of a First Embodiment of a Security Seal

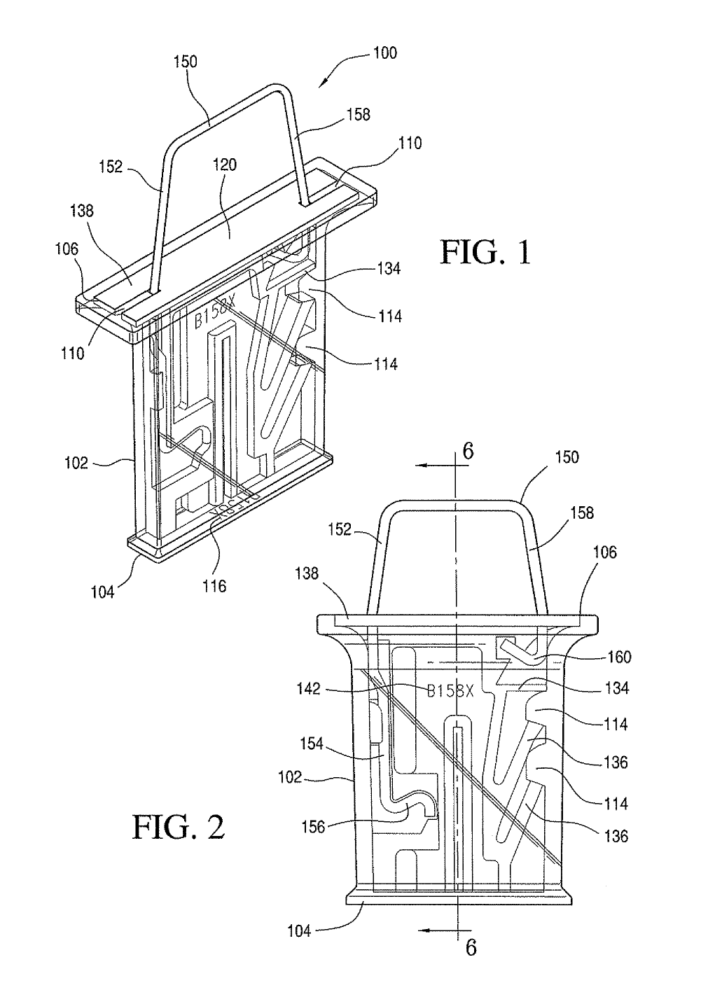

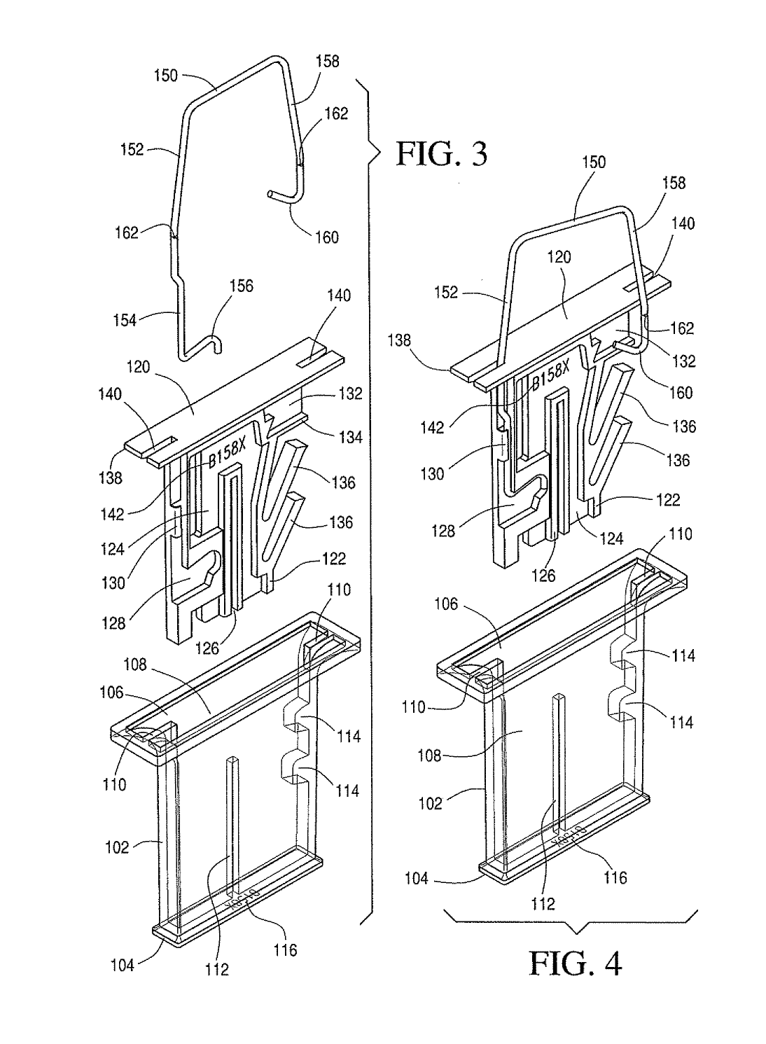

An embodiment of a security seal 100 according to the present disclosure is shown in FIGS. 1 and 3. The security seal 100 generally includes three components, an outer body 102, a locking insert 120, and a shackle 150.

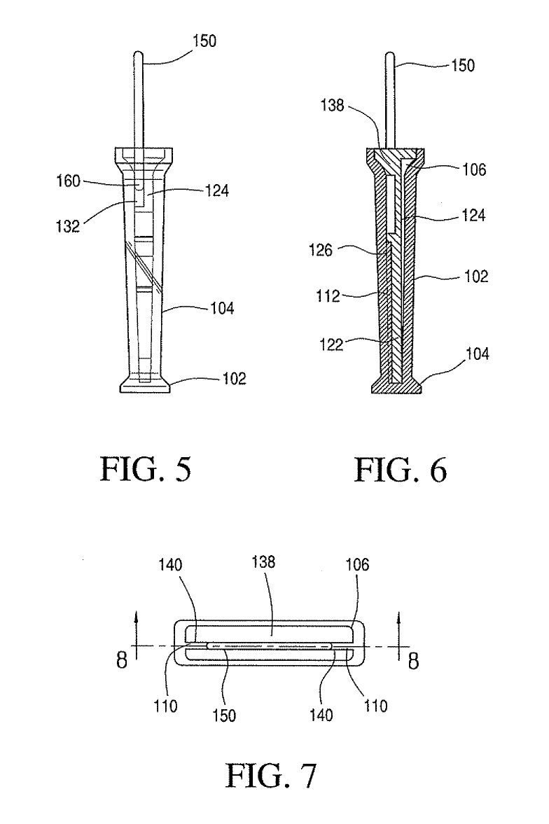

As best seen in FIGS. 1, 2, 5, 6, and 9, the shackle 150 and locking insert 120 are assembled together and are received and retained within the outer body 102, in a manner to be more fully discussed below. Once the components of the security seal 100 are assembled, the configuration of the security seal 100 discourages tampering therewith, since the unauthorized disassembly thereof will provide clear indication of tampering with the security seal 100, as discussed more fully below.

As best seen in FIGS. 2-4, the outer body 102 includes a base 104 at a first end thereof and a profiled opening 106 at a second end thereof, the profiled opening communicating with a cavity 108 defined within the outer body 102. In this manner, the outer body 102 is generally formed as a female part for receiving therein a male insert plug body 122 of the locking insert 120. The outer body 102 can be formed from any suitable material, such as metal or plastic. In the illustrated embodiment, the outer body 102 is formed of a transparent plastic material, so that any damage to the locking insert 120 or internal components of the outer body 102 can readily be discerned.

As can be seen in FIGS. 3 and 4, the cavity 108 includes structures configured to cooperate with the insert plug body 122 of the locking insert 120. In particular, a guide projection 112 is provided on an inner wall of the cavity 108.

As shown in FIGS. 6, 8, and 9, the guide projection 112 cooperates with a guide slot 126 formed on the locking insert 120 to ensure that the locking insert 120 is properly aligned and engaged with the outer body 102.

Referring to FIGS. 3 and 4, the cavity 108 also includes locking abutments 114 formed along an inner side wall thereof for cooperating in a locking manner with respective locking fingers 136 formed on the locking insert 120.

As mentioned above, the outer body 102 includes a profiled opening 106, as best seen in FIGS. 3 and 4. The profiled opening 106 is complementary shaped to a correspondingly profiled insert cover 138 of the locking insert 120. In the exemplary embodiment, the profiled opening 106 can include shackle leg clearance closing tabs 110 that cooperate to fill in shackle leg clearances 140 in the profiled insert cover 138 of the locking insert 120 to eliminate gaps in the security seal where a tool may be inserted to tamper with the security seal (see FIGS. 1, 7, and 8). While there will be small clearance/tolerance gaps in the security seal to allow assembly thereof, there will be no gaps of a sufficient size to allow a tool to be inserted to tamper with the security seal.

As shown in FIGS. 2-6, the profiled opening 106 is also configured to help guide the insert plug body 122 of the locking insert 120 into the cavity 108 for ease of assembly of the security seal. In particular, the exemplary profiled opening 106 can include gradually curved edges at the top of the cavity 108 that are curved towards the inside of the cavity 108. Preferably, the insert plug body of the locking insert is configured so that it can be assembled with the outer body 102 in a single orientation only to ensure proper assembly.

As is also shown best in FIGS. 3 and 4, the outer body 102 includes some unique indicia, or a unique identification number 116. While the identification number 116 is shown positioned on the bottom of the base 104 of the outer body 102, the identification number or other indicia 116 can be provided in any suitable position on the outer body 102. While the identification number 116 is shown on the exterior of the outer body 102, if the outer body is formed of a transparent material, the identification number 116 can be formed inside the outer body 102 or even within the material of the outer body 102. The identification number 116 can be formed in any suitable manner, such as by being integrally molded with the outer body 102.

As shown in FIGS. 3 and 4, the identification number or indicia 116 corresponds to a matching unique identification number or indicia 142 formed on the locking insert 120. The identification number or indicia 142 formed on the locking insert 120 can be formed on any suitable area of the locking insert 120 that is received within the outer body 102. In this manner, the locking insert 120 and outer body 102 form a unique security seal 100, such that removal and replacement of one of the locking insert 120 and outer body 102 will provide indication of tampering therewith, due to a mismatch between the identification number or indicia 116 of the outer body 102 and the indicia 142 formed on the locking insert 120.

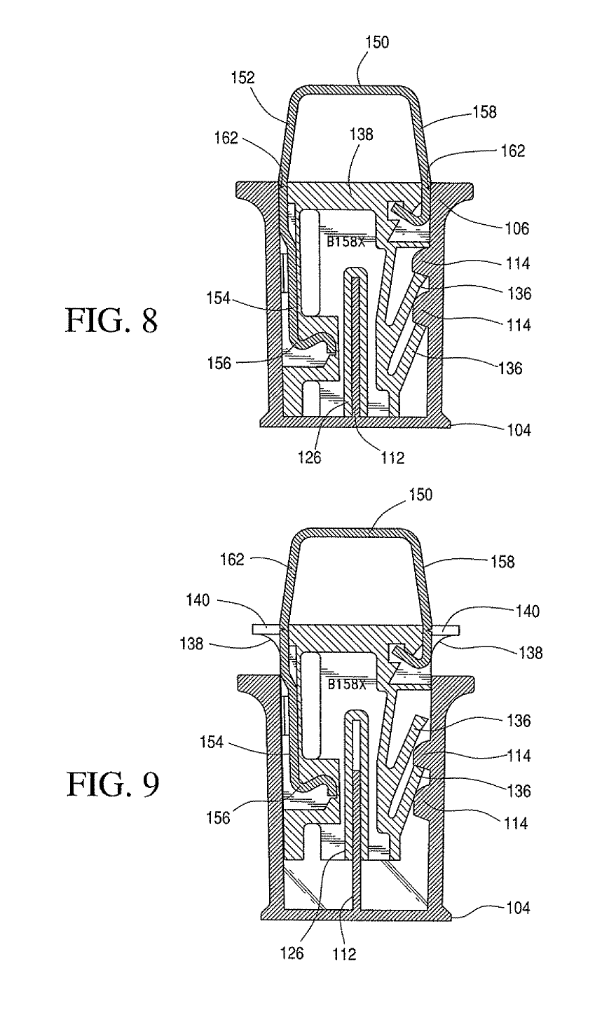

The structure of the locking insert 120 is further shown in FIGS. 8 and 9, as well as FIGS. 1-4. The locking insert 120 can be formed from any suitable materials, such as, for example, metal or plastic. The locking insert 120 includes a male insert plug body 122 that is defined by an insert plug body rear wall 124. A number of structures, discussed in detail below, are formed on the insert plug body rear wall 124. In particular, a first shackle hook receiver 128 and a shackle leg offset portion retainer 130 are positioned along a first side of the insert plug body 122 and are formed as projecting portions from the insert plug body rear wall 124. The first shackle hook receiver 128 and the shackle leg offset portion retainer 130 cooperate with a first shackle hook 156 and an offset portion 154 of a first shackle leg 152 to allow the shackle 150 to be engaged with the locking insert 120.

The male insert plug body 122 also includes a second shackle hook receiver 132, an insert bulkhead or wall 134 located just below and aligned with the receiver 132, and locking fingers 136 formed along a second side of the insert plug body 122 and formed as projecting portions from the insert plug body rear wall 124. The second shackle hook receiver 132 cooperates with a second shackle hook 160 of a second shackle leg 158 to allow the shackle 150 to be engaged with the locking insert 120.

The male insert plug body 122 also includes a guide slot 126 formed from projections extending from the insert plug body rear wall 124. The guide slot 126 extends from the distal or lower end of the insert plug body 122 towards the upper portion or insert cover 138 of the insert plug body 122. The insert plug body rear wall 124 is slightly offset from the center of the male insert plug body 122, such that the male insert plug body 122 can only be inserted into the cavity 108 of the outer body 102 if the guide slot 126 is aligned with the guide projection 112. In this manner, the locking insert 120 can only be inserted into the cavity 108 of the outer body 102 in one way, with the guide slot 126 aligned with the guide projection 112. If the male insert plug body 122 is rotated 180 degrees, the insert plug body rear wall 124 will contact the guide projection 112 to prevent the insertion of the insert plug body 122 into the cavity 108 of the outer body 102.

As shown in FIGS. 2, 8, and 9, the locking fingers 136 positioned along the second side of the insert plug body rear wall 124 cooperate with the locking abutments 114 formed along the inner side wall of the cavity 108 of the outer body 102 to prevent the removal of the locking insert 120 from the outer body 102 without damage once the locking insert 120 is engaged with the outer body 102. As can be seen, the locking fingers 136 are formed at an angle to the insert plug body 122, and are resilient, so that the locking fingers 136 pass over the locking abutments 114 when the male insert plug body 122 is inserted into the cavity 108 of the outer body 102. Once the locking fingers 136 have passed over the locking abutments 114, the ends of the locking fingers 136 abut against the locking abutments 114 to prevent the withdrawal of the locking insert 120 from the outer body 102 without damage to the security seal 100.

The upper portion of the locking insert 120 is formed into a profiled insert cover 138 that is complementary shaped to the profiled opening 106 of the outer body 102. The profiled insert cover 138 can include gradually curved surfaces that mate with the curved surfaces of the profiled opening 106 so that the locking insert 120 seats within the cavity 108 of the outer body 102, like a drawer. The locking insert 120 thus is received in a flush manner within the cavity 108 of the outer body 102.

The profiled insert cover 138 includes shackle leg clearances 140 that allow the first and second shackle legs 152, 158 to be assembled with and to pass through the insert cover 138 into the insert plug body 122 along the insert plug body rear wall 124. As shown in FIGS. 1 and 7, when the security seal 100 is assembled in a locking position, and the shackle legs 152, 158 are retained between outer body 102 and the locking insert 120, the shackle leg clearance closing tabs 110 cooperate with the shackle leg clearances 140 such that there are no exterior gaps (larger than necessary clearance/tolerance gaps for assembly thereof) between the shackle legs 152, 158 and the outer body 102 and the locking insert 120. In this manner, the security seal 100 is configured to prevent the insertion of a tool into the security seal, thus discouraging tampering. Further, if a tool is used to attempt to remove the shackle 150, since there are no gaps (other than clearance/tolerance gaps) for the insertion of a tool, either the outer body 102 or the locking insert 120 will show evidence (damage, such as scratches or gouges) of the tool insertion.

Additionally, if someone attempts to remove the second shackle leg 158, for example with acid, the insert bulkhead 134 prevents the insertion of a tool into the cavity 108 of the outer body 102 to manipulate the locking fingers 136. Thus, even if the shackle 150 is removed, the locking insert 120 cannot be removed from the cavity 108 of the outer body 102 without causing damage to either the locking insert 120 or the outer body 102.

As shown in the Figures, and in particular FIGS. 3, 8, and 9, and as substantially described above, the shackle 150 has a generally truncated U-shaped configuration with first and second shackle legs 152, 158 extending therefrom. The first shackle leg 152 also includes an offset portion 154 at the end thereof for insertion into the insert plug body 122. While the shackle 150 is shown having a generally truncated U-shaped configuration, it will be recognized that any suitable shape can be utilized. The shackle 150 can be formed from any suitable material, such as a metal wire. Exemplary metals can include any steel or aluminum alloy.

As already mentioned above, the first and second shackle legs 152, 158 each have respective first and second shackle hooks 156, 160 formed at the distal ends thereof. The first and second shackle legs 152, 158, or at least one of the shackle legs, also each have pre-weakened zones 162 formed therein.

As shown in FIG. 8, when the security seal is assembled, the pre-weakened zone or zones 162 are positioned within the body of the security seal 100 so as to be hidden from view. If attempts are made to bend the shackle 150, the pre-weakened zones 162 will either cause the shackle 150 to break, and thus indicate tampering, or the shackle legs 152, 158 will permanently deform at the pre-weakened zones 162, and thus indicate tampering.

Turning back to FIGS. 3, 4, and 8, the security seal 100 can be shipped or provided in a disassembled, or in a partially assembled manner. As shown in FIG. 4, the first shackle hook 156 can be inserted into the first shackle hook receiver 128 and the offset portion 154 of the first shackle leg 152 is retained by the shackle leg offset portion retainer 130. The shackle leg offset portion retainer 130 is configured to allow the offset portion 154 of the first shackle leg 152 to rotate therein so that the second shackle hook 160 can be positioned outside of the shackle leg clearance 140 in the insert cover 138. In this manner, the locking insert 120 can be prevented from accidental engagement with the outer body 102.

When it is desired to further assemble the security seal 100, as shown in FIG. 9, the second shackle hook 160 can be secured within the second shackle hook receiver 132. Then, the locking insert 120 can be inserted into the cavity 108 of the outer body 102 until one of the locking fingers 136 passes over and abuts with the first locking abutment 114. In this configuration, the second shackle hook 160 can be removed from within the second shackle hook receiver 132 to allow the shackle to be connected to the meter, receptacle, or other device.

Once the shackle has been secured to the device, the second shackle hook 160 can again be secured within the second shackle hook receiver 132, and the locking insert 120 fully inserted into the cavity 108 of the outer body 102 until both locking fingers 136 have passed over and abut the locking abutments 114, as shown in FIG. 8. As previously discussed, once the locking insert 120 is fully inserted into the cavity 108 of the outer body 102, the locking fingers 136 and locking abutments 114 cooperate to prevent the removal of the locking insert 120 from the cavity 108, without causing damage to the security seal 100.

Further, since there are no gaps, other than the necessary clearance/tolerance gaps, between the shackle legs 152, 158 and the outer body 102 and the locking insert 120, a tool cannot be used to remove the shackle 150 without causing damage to the security seal 100.

Even further still, even if the shackle 150 is removed, the insert bulkhead 134 prevents the locking insert 120 from being removed from the cavity 108 of the outer body 102 without causing damage to either the locking insert 120 or the outer body 102.

Still further, even if the locking insert 120 is removed from the cavity 108 of the outer body 102, without causing damage to the outer body, there will inherently be damage to the locking insert 120. However, the matching indicia or identification numbers 116, 142 on the outer body 102 and the locking insert 120 prevent the simple replacement of the damaged locking insert 120 with a new locking insert.

Even further still, the pre-weakened zones 162 in the shackle legs 152, 158 will show evidence of tampering via breakage or permanent deformation if the shackle 150 is bent. In other words, the shackle 150 cannot first be bent from the original configuration and then be bent back into the original configuration, since pre-weakened zones 162 in the shackle legs 152, 158 will show evidence of tampering via breakage or permanent deformation thereof.

### B. Detailed Description of a Second Embodiment of a Security Seal

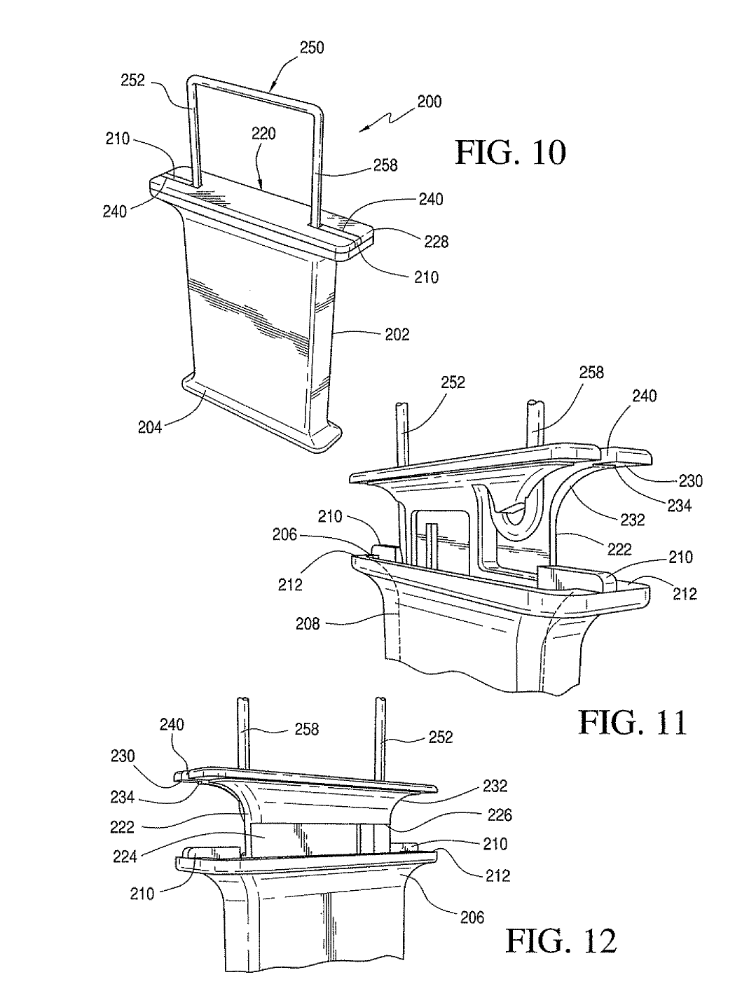

Another embodiment of a security seal 200 in accordance with the present disclosure is shown in FIGS. 10 and 11. The features of this embodiment of a security seal 200 are substantially similar to the embodiment discussed above.

In particular, like security seal 100, the security seal 200 generally includes three components, an outer body 202, a locking insert 220, and a shackle 250, which may have any desired shape, but is shown having a generally rectangular U-shape. The security seal 200 can include all of the security features discussed above, including transparent components and unique identification number or indicia. Further, the assembly of the security seal 200, including the internal components formed on the locking insert 220 and the internal features of the outer body 202, such as guide slots, locking fingers, guide projections, and locking abutments, are the same as discussed above with respect to the security seal 100, and these features are not further discussed here.

Like the security seal 100, the outer body 202 of the security seal 200 includes a base 204, and a profiled opening 206 leading into a cavity 208, which generally forms a female portion of the security seal 200. As with security seal 100, a guide projection and locking abutments can be formed within the cavity 208.

As best seen in FIGS. 11 and 12, a mating surface 212 is formed at the top portion of the outer body 202 around the periphery of the profiled opening 206. At opposed sides of the profiled opening 206 shackle leg clearance closing tabs 210 extend partially into the profiled opening 206, as well as above the mating surface 212 in order to form projecting portions. As discussed in more detail below, the shackle leg clearance closing tabs 210 are configured to eliminate gaps in the assembled security seal 200 (other than clearance/tolerance gaps).

As seen in FIGS. 10-12, the locking insert 220 (generally forming a male portion of the security seal 200) includes an insert plug body 222 generally formed as previously discussed with respect to the insert plug body 122, including features such as a guide slot, first and second shackle hook receivers, insert bulkhead, and locking fingers.

As can be seen in FIG. 12, the insert plug body 222 includes an insert plug body rear wall 224, which may include a rear wall ledge 226. The rear wall ledge 226 may cooperate with a projection within the cavity 208 in order to aid with limiting the extent that the insert plug body 222 is inserted into the cavity 208, and can provide an additional mechanism to prevent the insertion of a tool within the cavity by eliminating any gap between the insert plug body 222 and the inner wall of the cavity 208.

As best seen in FIGS. 11 and 12, the insert plug body 222 also includes an insert cover/cap portion 228. The cap portion 228 has a mating surface 230 on the underside thereof, which, when the insert plug body 222 is inserted into the cavity 208 of the outer body 202 closely mates with the mating surface 212 of the outer body 202 (FIG. 12) in order to prevent the insertion of any tool within the cavity 208.

Located beneath the mating surface 230 is a profiled portion 232 that is complementary shaped to the profiled opening 206 leading into the cavity 208 of the outer body 202. The profiled portion 232 may include a separation edge 234 formed between the profiled portion 232 and the mating surface 230, which edge may be generally perpendicularly oriented with respect to the mating surface 230. In the drawings, this separation edge 234 is shown in an exaggerated size in order to better illustrate the edge 234. The edge 234 may also be generally sloped, as opposed to perpendicularly oriented, in order to provide a cleaner transition between the mating surface 230 and the profiled portion 232, or in an alternative configuration, there may be no separation edge provided between the mating surface 230 and the profiled portion 232, such that the profiled portion 232 is generally contiguously formed extending from the mating surface 230.

As can be seen in FIG. 10, shackle leg clearances or slots 240 are provided in the cap portion 228 to accommodate the first and second shackle legs 252, 258. When the locking insert 220 is assembled with the outer body 202 of the security seal, the first and second shackle legs 252, 258 are positioned within the shackle leg clearances 240, which clearances are then closed off by the shackle leg clearance closing tabs 210, which project above the mating surface 212. Thus, when the security seal 200 is assembled, there are no exterior gaps (larger than necessary clearance/tolerance gaps for assembly thereof) between the shackle legs 252, 258 and the outer body 202 and the locking insert 220. In this manner, the security seal 200 is configured to prevent the insertion of a tool into the security seal, thus discouraging tampering.

With this configuration of the embodiment of the security seal 200 shown in FIGS. 10-12, and in particular, the complimentary shapes of the profiled opening 206, the profiled portion 232, the separation edge 234, and the mating surfaces 212, 230, it is very difficult to insert a tool between the locking insert 220 and the outer body 202 of the security seal 200. Additionally, even if a tool is able to be inserted between the mating surface 212 of the outer body 202 and the mating surface 230 of the cap portion 228, because of the separation edge 234 and profiled portion 232, and further due to the close fit between the complementary shaped profile portion 232 and profiled opening 206, it is extremely difficult to insert a tool beyond the separation edge 234 and into the internal cavity 208 of the outer body 202 of the security seal 200.

Thus, and in particular in view of the internal configuration of the security seal 200, as described above in detail with respect to the security seal 100, even if a tool were inserted between the locking insert 220 and the outer body 202 of the security seal 200, the two pieces cannot be separated from each other without damage to one or both pieces, which damage will be visually detectable. Similarly, if acid is used to dissolve the shackle legs 252, 258, a new shackle cannot be inserted without disassembling the locking insert 220 from the outer body 202 of the security seal 200, which as previously discussed, will damage one or both of the locking insert 220 and the outer body 202.

### C. Detailed Description of Third Embodiment of a Security Seal

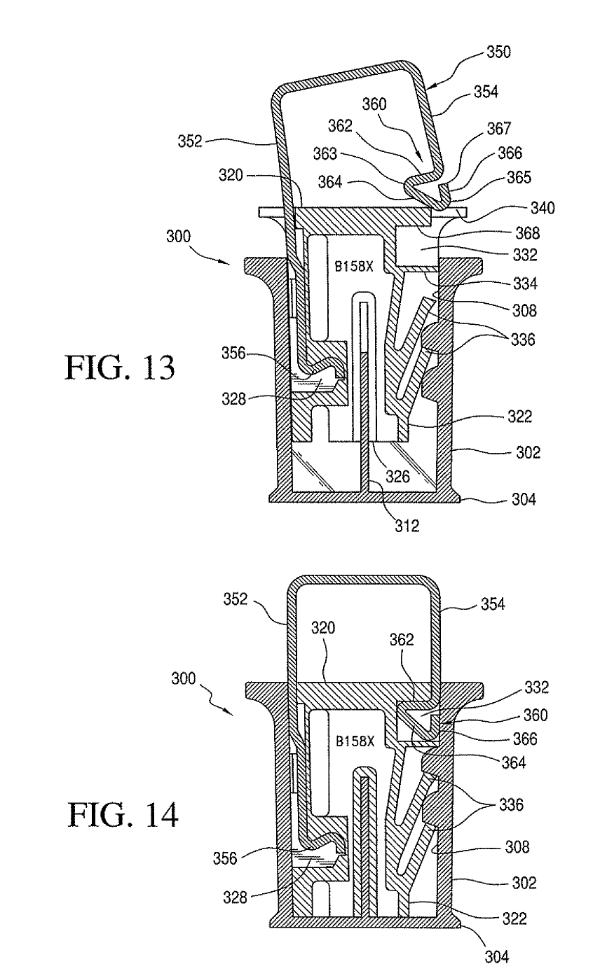

With reference to FIGS. 13 and 14, a third preferred embodiment of a security seal 300 is shown, wherein the outer body 302 may conform to the outer bodies 102 and 202 of the first and second embodiments described above, including a base 304, cavity inner wall 308 and a profiled upper opening corresponding with openings 106 and 206 of the first and second embodiments. A guide projection 312 in the outer body cooperates with a guide slot 326 of the locking insert 322 in a manner similar to the first embodiment. The locking insert 322 with cover 320 corresponds essentially with inserts 122 and 222, and includes a first shackle hook receiver 328, and locking fingers 336, all corresponding with the shackle hook receiver 128 of the first embodiment.

A different feature of this third embodiment comprises a U-shaped bent wire shackle 350 having an integral first shackle hook 356 on one distal end of a first leg 352 of the U-shaped wire shackle similar to the first embodiment, that cooperates with the first shackle hook receiver 328 of the locking insert 322 and also a second integral shackle hook 360 at the distal end of the opposite second leg 354 of the wire shackle that cooperates with a second shackle hook receiver 332, and that is bent in the general shape of a triangle, including a first return leg 362 of the hook that is turned inward relative to the second leg 354 of the shackle toward the central portion of the shackle and terminating at a first end area 363, a second hook leg 364 of the hook depending downwardly and outwardly away from the end area of the first hook leg and terminating at a second end area 365, and a third hook leg 366 extending upwardly generally aligned with the second shackle leg 354 from the second end area and terminating at an end 367 of the second shackle wire leg 354. All three hook legs of the second hook, as shown, lie essentially in a common plane with the legs 352, 354 and first hook 356 of the shackle 350.

The U-shaped shackle wire 350, like the first and second embodiments, is normally disposed in an unsecured position when the seal is in the unsealed position of FIG. 13 with the first hook engaged with the insert first shackle hook receiver 328 and with the second hook portion disposed outside the second shackle hook receiver 332 of the locking insert so that the shackle can be engaged with a structure to be sealed or secured, for example, an electric usage meter (not shown), although the shackle normally would be oriented so that the shackle can be readily engaged with the structure to be secured. The relaxed form of the U-shaped wire shackle 350 in this embodiment would result in the second hook being located with the first leg 352 of the shackle in a relaxed linear position, with the first hook 356 located in its respective hook receiver 328, and with the second hook 350 located outside the respective shackle hook clearance 340 and outside the second hook receiver 332. The second shackle hook receiver 332 of the locking insert includes a generally horizontal upper wall 368 that cooperates with the first return leg of the second hook when the locking insert, shackle and outer body are assembled in the locking position, as shown in FIG. 14 and described below, and a lower bulkhead or wall 334.

The diagonally sloping second leg 364 of the second shackle hook facilitates assembly of the shackle to the locking insert when the security seal is assembled in the locking position of FIG. 14 with the shackle engaging a structure to be sealed by enabling the camming of the second leg 364 over the free inner edge of the shackle leg clearance 340 when the leg 364 is located as shown in FIG. 13 so the second hook can be pressed with one hand towards the locking insert and the second hook can be pressed into the second hook receiver 332 with ease, where it engages the receiver with a snap action and with the return first leg 362 of the second hook engaged against the upper wall 368 of the second hook receiver 332 as seen in FIG. 14.

The triangular shape of the second hook, when the locking insert, shackle and outer body are assembled into a securing position as shown in FIG. 14, also provides increased security against surreptitious or undetectable separation of the shackle from the locking insert by providing a self-securing effect when an attempt is made to pull the second leg 354 of the shackle on which the second hook 360 is provided out of the outer body 302. When a pulling force is applied to the second leg 354 of the shackle 350, the triangular shape of the second hook 360 will cause the upper horizontal return leg 362 to be pressed against the upper wall 368 of receiver 332 which will force the second leg 364 diagonally downward and outward toward the inner wall 308 of the outer body via the third leg 366 of the second hook. Even if the first and second hook legs could effectively be straightened out and aligned by a pulling force that did not already rupture the second leg of the shackle, the insert or the outer body, it still would not be possible to pull the second leg out of the outer body due to the doubling over of the second and third legs in the receiver 322, thereby making it virtually impossible to pull out this leg of the shackle from the outer body without creating visible damage to the security lock parts.

If less security is acceptable for certain applications of the security seal, the second hook leg could terminate at the second end area adjacent to the inner wall of the outer body, as this would reinforce the first hook leg against being straightened out by a pulling force applied to the second shackle leg.

Therefore, it can be seen that the embodiments of the security seals 100, 200 and 300 described herein provide improved security seals that prevent undetectable tampering.

### D. Conclusion

It will be recognized that the security seals described herein are appropriately sized so as to be manipulated by hand, and may even be manipulated using a single hand. However, it is understood that the size of the disclosed embodiments and the components thereof can be adjusted within the scope of the present disclosure.

It is also understood that the locations of various structural features may be altered from the positions as illustrated herein. In particular, the position of the guide groove and guide slot can be alternated.

Of course, it is to be understood that not necessarily all objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The skilled artisan will recognize the interchangeability of various disclosed features from the disclosed embodiments and variations. In addition to any variations described herein, other known equivalents for each feature can be mixed and matched by one of ordinary skill in this art to construct a security seal in accordance with principles of the present invention.

Although this invention has been disclosed in the context of exemplary embodiments and examples, it therefore will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

What is claimed is:

1. A security seal comprising:
an outer body having a cavity;
a locking insert adapted to be received in the cavity and permanently secured therein against removal; and
a shackle adapted to be carried by the locking insert for placement in the cavity with the locking insert and permanently secured therein against removal;
said outer body, locking insert and shackle being configured such that when assembled together in a sealing position no exterior gaps providing access to the outer body cavity are presented between them.

2. The security seal according to claim 1, wherein said shackle includes at least a pair of shackle legs and the locking insert includes a cover including shackle openings through which the shackle legs extend upon assembly of the shackle and locking insert, and the outer body has a body opening closed by the cover when the locking insert, shackle and outer body are assembled in a sealing position, said cover, shackle legs, shackle openings and body opening having complementary shapes that result in all exterior gaps providing access to the outer body cavity when said locking insert, shackle legs, and outer body are assembled in a sealing position being closed.

3. The security seal according to claim 2, at least one of said shackle legs including a pre-weakened portion disposed within the outer body adjacent the locking insert cover when the seal is assembled in the locking position.

4. The security seal according to claim 2, wherein the locking insert includes a shackle leg receiving and securing element for a shackle leg beneath the locking insert cover when the seal is assembled in a locking position, and a bulkhead extending beneath the shackle leg receiving element blocking any direct access path between the shackle opening for the respective shackle leg in the locking insert cover and the interior of the outer body below the bulkhead.

5. The security seal according to claim 2, wherein when the security seal is assembled, the locking insert cover sits flushly within the body opening of the cavity of the outer body.

6. The security seal according to claim 2, wherein the insert cover includes a cap portion having a mating surface along an underside thereof, such that when the security seal is assembled, the mating surface of the locking insert cover mates with a mating surface defined around a periphery of the body opening of the cavity of the outer body.

7. The security seal according to claim 1, wherein a guide projection is provided on an inner wall of the cavity of the outer body and a guide slot is formed on the locking insert arranged to cooperate with the guide projection to align the locking insert with the outer body.

8. The security seal according to claim 1, wherein said locking insert and outer body are provided with a matching unique identifier.

9. The security seal according to claim 1, wherein the locking insert includes at least one locking finger configured to pass over and engage at least one locking abutment formed in the cavity when the security seal is assembled in order to prevent the disassembly thereof.

10. The security seal according to claim 1, wherein the shackle comprises a generally U-shaped wire shackle that lies in a common plane and includes a leg including at a distal end area thereof a portion of the shackle leg bent into a generally triangular shaped locking hook that engages the locking insert within the outer body when the security seal is in the sealing position, the locking insert including a locking hook receiver area in which the locking hook is disposed when the locking insert is in the sealing position within the outer body, said receiver having an upper wall that engages a portion of the triangular locking hook when the security seal is in the sealing position to resist pulling of the shackle leg out of the outer body.

11. The security seal according to claim 10, wherein the locking hook includes an upper first hook leg extending substantially horizontally inwardly relative to the shackle leg and terminating at first end portion; and at least a second hook leg extending downwardly and outwardly from the first end portion, and terminating at a second end portion; said first hook leg portion engaging the locking hook receiver upper wall and the second end portion of the second hook leg disposed adjacent to an inner wall of the outer body when the locking insert is in the sealing position; said first hook leg, first end portion, second hook leg and second end portion laying in a common plane with the U-shaped wire shackle.

12. The security seal according to claim 11, wherein the locking hook includes a third hook leg extending from the second end portion upwardly generally aligned with the shackle leg adjacent to an inner wall of the outer body when the locking insert is in the sealing position, said third leg laying in a common plane with said U-shaped wire shackle.

13. The security seal according to claim 1, wherein the cover of the locking insert includes shackle openings through which the shackle legs extend upon assembly of the shackle and locking insert, and the outer body includes closing tabs that cooperate to fill in the shackle openings when the security seal is assembled.

14. A security seal comprising:
an outer body having a body opening leading into a cavity;
a locking insert adapted to be received in the cavity and permanently secured therein against removal; and
a shackle having at least two shackle legs adapted to be carried by the locking insert for placement in the cavity with the locking insert and permanently secured therein against removal;
wherein the locking insert includes a cover including shackle openings through which the shackle legs extend upon assembly of the shackle and locking insert, and the body opening is closed by the cover when the locking insert, shackle and outer body are assembled in a sealing position, said cover, shackle legs, shackle openings and body opening having complementary shapes that result in all exterior gaps providing access to the outer body cavity when said locking insert, shackle legs, and outer body are assembled in a sealing position being closed.

15. The security seal according to claim 14, at least one of said shackle legs including a pre-weakened portion disposed within the outer body adjacent the locking insert cover when the seal is assembled in the locking position.

16. The security seal according to claim 14, wherein the locking insert includes a shackle leg receiving and securing element for a shackle leg beneath the locking insert cover when the seal is assembled in a locking position, and a bulkhead extending beneath the shackle leg receiving element blocking any direct access path between the shackle opening for the respective shackle leg in the locking insert cover and the interior of the outer body below the bulkhead.

17. The security seal according to claim 14, wherein when the security seal is assembled, the locking insert cover sits flush within the body opening of the cavity of the outer body.

18. The security seal according to claim 14, wherein the insert cover includes a cap portion having a mating surface along an underside thereof, such that when the security seal is assembled, the mating surface of the locking insert cover mates with a mating surface defined around a periphery of the body opening of the cavity of the outer body.

19. The security seal according to claim 14, wherein a guide projection is provided on an inner wall of the cavity of the outer body and a guide slot is formed on the locking insert arranged to cooperate with the guide projection to align the locking insert with the outer body.

20. The security seal according to claim 14, wherein said locking insert and outer body are provided with a matching unique identifier.

21. The security seal according to claim 14, wherein the shackle comprises a generally U-shaped bent wire shackle that lies in a common plane and that includes said legs, one of said legs including at a distal end area thereof a portion of the shackle leg bent into a generally triangular shaped locking hook that engages the locking insert within the outer body when the security seal is in the sealing position, the locking insert including a locking hook receiver area in which the locking hook is disposed when the locking insert is in the sealing position within the outer body, said receiver having an upper wall that engages a portion of the triangular locking hook when the security seal is in the sealing position to resist pulling of the respective shackle leg out of the outer body.

22. The security seal according to claim 21, wherein the locking hook includes an upper first hook leg extending substantially horizontally inwardly relative to the respective shackle leg and terminating at first end portion; and at least a second hook leg extending downwardly and outwardly from the first end portion, and terminating at a second end portion; said first hook leg portion engaging the locking hook receiver upper wall and the second end portion of the second hook leg disposed adjacent to an inner wall of the outer body when the locking insert is in the sealing position; said first hook leg, first end portion, second hook leg and second end portion laying in a common plane with the U-shaped wire shackle.

23. The security seal according to claim 22, wherein the locking hook includes a third hook leg extending from the second end portion upwardly generally aligned with the respective shackle leg adjacent to an inner wall of the outer body when the locking insert is in the sealing position; said third leg laying in a common plane with said U-shaped wire shackle.

24. A security seal comprising:
an outer body having a body opening leading into a cavity;
a locking insert adapted to be received in the cavity and permanently secured therein against removal; and
a shackle having at least two shackle legs adapted to be carried by the locking insert for placement in the cavity with the locking insert and permanently secured therein against removal;
wherein the locking insert includes a cover including shackle openings through which the shackle legs extend upon assembly of the shackle and locking insert, and the body opening is closed by the cover when the locking insert, shackle and outer body are assembled in a sealing position, said cover, shackle legs, shackle openings and body opening having complementary shapes that result in all exterior gaps providing access to the outer body cavity when said locking insert, shackle legs, and outer body are assembled in a sealing position being closed; and
wherein the cover of the locking insert includes shackle openings through which the shackle legs extend upon assembly of the shackle and locking insert, and the outer body includes closing tabs that cooperate to fill in the shackle openings when the security seal is assembled.

25. The security seal according to claim 24, wherein when the security seal is assembled, the locking insert cover sits in a flush manner within the body opening of the cavity of the outer body.

26. The security seal according to claim 24, wherein the insert cover includes a cap portion having a mating surface along an underside thereof, such that when the security seal is assembled, the mating surface of the locking insert cover mates with a mating surface defined around a periphery of the body opening of the cavity of the outer body.

27. The security seal according to claim 24, wherein the shackle comprises a generally U-shaped bent wire shackle that lies in a common plane and that includes said legs, one of said legs including at a distal end area thereof a portion of the shackle leg bent into a generally triangular shaped locking hook that engages the locking insert within the outer body when the security seal is in the sealing position, the locking insert including a locking hook receiver area in which the locking hook is disposed when the locking insert is in the sealing position within the outer body, said receiver having an upper wall that engages a portion of the triangular locking hook when the security seal is in the sealing position to resist pulling of the respective shackle leg out of the outer body.

28. The security seal according to claim 27, wherein the locking hook includes an upper first hook leg extending substantially horizontally inwardly relative to the respective shackle leg and terminating at first end portion; and at least a second hook leg extending downwardly and outwardly from the first end portion, and terminating at a second end portion; said first hook leg portion engaging the locking hook receiver upper wall and the second end portion of the second hook leg disposed adjacent to an inner wall of the outer body when the locking insert is in the sealing position; said first hook leg, first end portion, second hook leg, and second end portion laying in a common plane with the U-shaped wire shackle.

29. The security seal according to claim 28, wherein the locking hook includes a third hook leg extending from the second end portion upwardly generally aligned with the respective shackle leg adjacent to an inner wall of the outer body when the locking insert is in the sealing position; said third leg laying in a common plane with said U-shaped wire shackle.

30. A shackle for a security seal comprising an approximately U-shaped continuous bent wire laying in a single plane and having first and second depending legs, said legs including locking hooks formed of the bent wire at distal ends thereof; at least one of the locking hooks comprising a portion of the bent wire having an approximately triangular shape, said portion comprising a first hook leg extending inwardly generally horizontally towards a central area of the shackle and terminating at a first end area; a second leg extending downwardly and outwardly from the first end area, and terminating at a second end area; and a third leg extending upwardly from the second end area in a direction approximately aligned with the respective shackle leg; said hook legs laying in said common plane with the U-shaped bent wire of the shackle.
